(19) United States
(12) Patent Application Publication
(10) Pub. No.: US 2010/0169198 A1
(43) Pub. Date: Jul. 1, 2010

(54) BILLING A LISTER FOR LEADS RECEIVED FROM POTENTIAL RENTERS WITHIN A LEAD THRESHOLD

(75) Inventors: Robert N. Canning, Los Angeles, CA (US); Robert Holden, Los Angeles, CA (US); Adrienne Go, San Francisco, CA (US); Curtis Thornhill, Santa Monica, CA (US); William McKnight, Los Angeles, CA (US)

Correspondence Address: SCHWEGMAN, LUNDBERG & WOESSNER/EBAY, P.O. BOX 2938, MINNEAPOLIS, MN, 55402, US

(73) Assignee: EBAY INC., SAN JOSE, CA (US)

(21) Appl. No.: 12/346,754

(22) Filed: Dec. 30, 2008

(51) Int. Cl. G06Q 30/00; G06Q 50/00

(52) U.S. Cl. 705/34

(57) ABSTRACT

In some example embodiments, a system and method are illustrated to bill a lister for lead received from potential renters within a lead threshold. The system and method include setting a lead threshold for a lister. The lead threshold may specify a maximum number of leads relating to a property listing that will be communicated to the lister. The system and method include receiving a lead from potential renters. The lead may be related to the property listing associated with the lister. The system and method include automatically determining whether the lead threshold has been exceeded. The system and method include communicating the lead to the lister based on a determination that the lead threshold has not been exceeded. The system and method further include billing the lister according to a number of leads related to the property listing communicated to the lister.

### CROSS REFERENCE TO RELATED APPLICATIONS

The present application is related to United States Patent Application Publication Number 2007/0003038 A1 entitled “SYSTEM TO CAPTURE COMMUNICAION INFORMATION” that was published on Jan. 4, 2007. The content of the publication is incorporated by reference in its entirety.

### COPYRIGHT

A portion of the disclosure of this document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots that may be described below and in the drawings that form a part of this document: Copyright© 2008, eBay Inc. All Rights Reserved.

### TECHNICAL FIELD

Example embodiments relate generally to the technical field of algorithms and programming and, in an example, to allowing a lister to list his or her properties in an online listing system and billing the lister for the listing.

### BRIEF DESCRIPTION OF THE DRAWINGS

Some embodiments are illustrated by way of example and not limitation in the figures of the accompanying drawings in which:

FIG. 1 is a diagram of a computer system for billing a lister based upon the number of leads received from potential renters in accordance with an example embodiment.

FIG. 2 is a diagram of functional units of an online listing system in accordance with an example embodiment.

FIG. 3 is a flow chart illustrating a method used to bill a lister according to the number of leads received from potential renters in accordance with an example embodiment.

FIG. 4 is a diagram illustrating a mask table for use in the system of FIG. in accordance with an example embodiment.

FIG. 5 is a diagram showing an example computer system that executes a set of instructions to perform any one or more of the methodologies discussed herein.

### DETAILED DESCRIPTION

The emergence of an online listing system (e.g., such as eBAY, Amazon, and Rent.com in which goods/services are offered to interested parties) has created new opportunities for a service provider to monetize transactions made between a user (e.g., a renter, a buyer, a prospective buyer, a mortgagor, etc.) and a lister (e.g., a landlord, a seller, a rental manager, a mortgagee, etc.) connected through the online listing system. It is important for the service provider to first identify when a transaction has been made between the user and the lister.

Numerous techniques exist for the service provider (e.g., an operator of the online listing system) to identify distinct users to allow payment of fees for each distinct users. In such a case, the service provider may also identify communications between a distinctive user and the lister when the user and the lister communicate via the Internet (e.g., through email, instant messenger, etc.). For example, the service provider can find the transaction by monitoring and/or reading emails between the user and the lister when they communicate with each other through emails sent to each other through the online listing system. In particular, the patent application publication US 2007/0003038 A1 discloses an apparatus and method to mask users' (e.g., potential renters and listers) identities to each other and track communications (e.g., leads) between them using a proxy contact information (e.g., proxy telephone number or a proxy e-mail address, etc.).

Once the transaction is identified, the service provider can charge the user and/or the lister a transaction fee (e.g., such as a fee when a particular property has been rented through a website such as Rent.com). The existing software, prior to our invention, did not allow us to distinguish sufficiently to assure that lister is charged only for a first contact by a potential renter with respect to a rental listing.

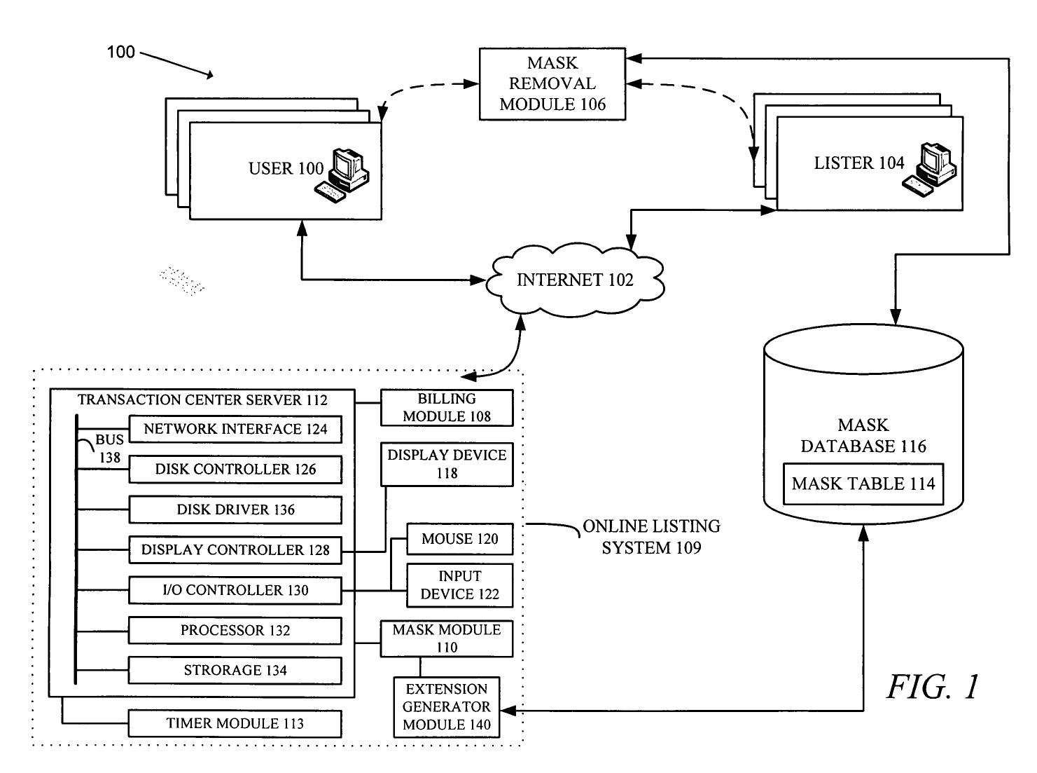

In some example embodiments, a system and method are illustrated to bill a lister for lead received from potential renters within a lead threshold. The system and method include setting a lead threshold for a lister. The lead threshold may specify a maximum number of leads relating to a property listing that will be communicated to the lister. The system and method include receiving a lead from potential renters. The lead may be related to the property listing associated with the lister. The system and method include automatically determining whether the lead threshold has been exceeded. The system and method include communicating the lead to the lister based on a determination that the lead threshold has not been exceeded. The system and method further include billing the lister according to a number of leads related to the property listing communicated to the lister. More detailed explanation about the billing of the lister within a lead threshold is given below using FIGS. 1-5.

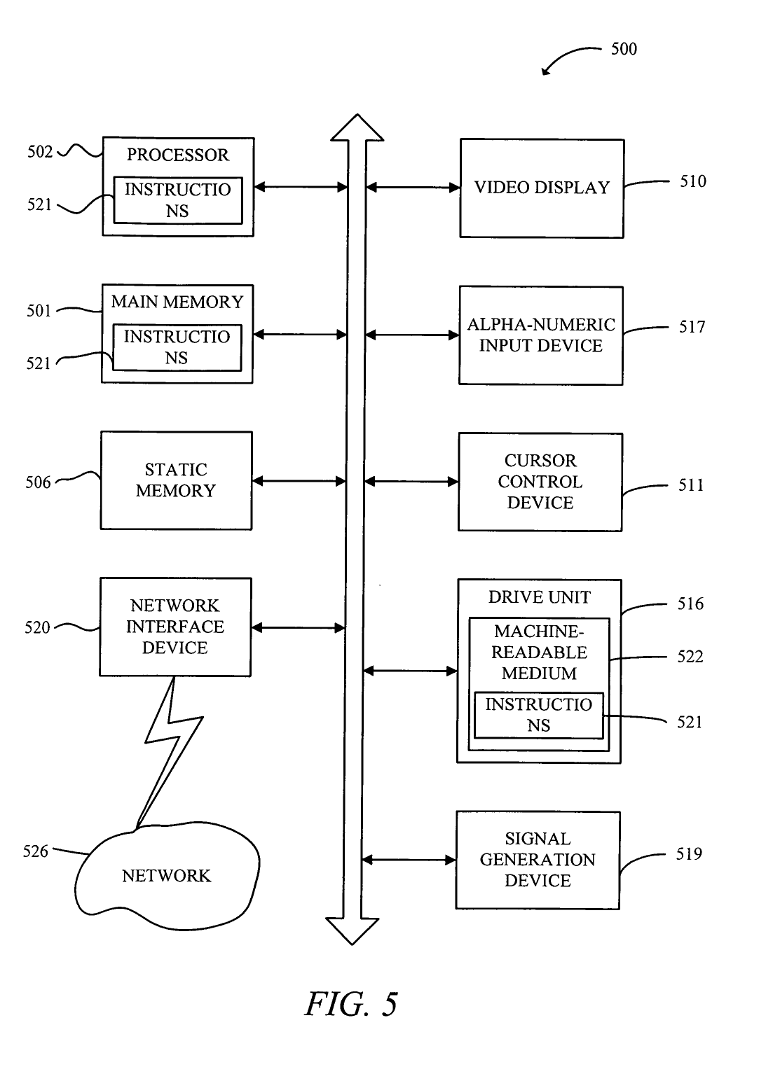

FIG. 1 is a diagram of a computer system for billing a lister based upon the number of leads received from potential renters 100 in accordance with an example embodiment. In particular, FIG. 1 shows a system view of an online listing system 109 associated with a mask table 114 and connected to a user (e.g., potential renter) 101 and a lister 104 through a network (e.g., an Internet 102) according to an embodiment. The user 101 communicates with the lister 104 through the Internet 102 (e.g., by accessing and searching on an online listing system such as Rent.com), in an example use scenario. In addition, the user 101 may directly communicate with the lister 104 offline through a telephone conversation (e.g., through a mask removal module 106). The mask removal module 106 may reside anywhere in the telephone network (e.g., a circuit switched and/or IP network), and serve as a gateway for offline communications between the user 101 and the lister 104. For example, the mask removal module 106 may reverse the encoding of a phone number that is ‘masked’ or encoded by a mask module 110 of the online listing system 109. More detailed description about the mask removal module 106 is described in the patent application publication US 2007/0003038 A1 (e.g., FIG. 5).

A transaction center server 112 (e.g., a transaction center server associated with the online listing system 109) may communicate with a billing module 108 and a mask module 110 connected to the transaction center server 112. The transaction center server 112 may also be connected to a display device 118, an input device 122, and a mouse 120, according to an embodiment illustrated in FIG. 1. The transaction center server 112 (e.g., a computer system) includes a network interface 124, a disk controller 126, a disk drive 136, a display controller 128, an I/O controller 130, a processor 132 (e.g., a microprocessor), and a storage 134 (e.g., a hard drive, a dynamic random access memory, and/or a flash memory, etc.) connected to each other through a bus 138 according to an embodiment illustrated in FIG. 1. The I/O controller 130 connects the transaction center server 112 to the input device 122 and the mouse 120 according to the embodiment of FIG. 1. More detailed explanation about a general architecture for a computer system is given below using FIG. 5.

The mask module 110 of the online listing system 109 may generate unique telephone extensions to identify different users (e.g., such as the user 101) of the online listing system using an extension generator module 140. A particular extension generated by the extension generator module 140 may be visible in each listing visited by the user 101 in the online listing system (e.g., each property visited by the user 101 in an online listing system for property rentals). Similarly, the mask module 110 may determine a proxy telephone number (e.g., a substitute phone number to mask an actual telephone number) for each listing posted in the online listing system 109 (e.g., every property posted by a rental manager on the online listing system).

When the user 101 calls in connection with a particular listing, the mask module 110 may determine an identity of the user 101 dialing the proxy telephone number (e.g., by consulting a mask table 114) based on an extension number entered by the user 101 (e.g., an extension number previously generated by an extension generator module 140 connected to the mask module 110). Based on this identity determination, the mask module 110 may update data in the storage 134 associated with the billing module 108 (e.g., to track a particular call and later bill the lister 104 and/or the user 101).

The mask module 110 may consult a mask table 114 of the mask database 116 (e.g., the mask database 116 may be stored in the storage 134 and/or external to the transaction center server 112 in various embodiments). In addition, the mask module 110 may communicate with the mask removal module 106 and permit the mask removal module 106 to convert the proxy telephone number to an actual telephone number of the lister 104 and route a call from the user 101 to the lister 104. The mask removal module 106 may then route the proxy telephone number to the lister 104 from the user 101 after the conversion is made according to an embodiment.

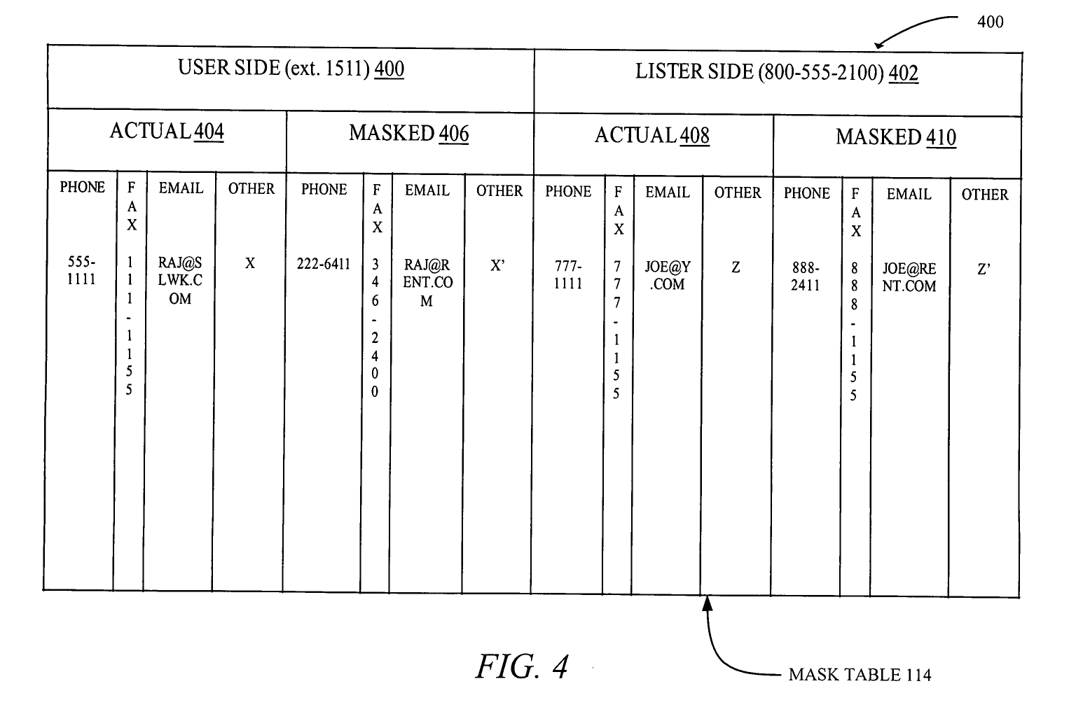

A detailed view of the mask table 114 is illustrated in FIG. 4 The mask table 114 as illustrated in FIG. 4 includes a user-side data 400 (e.g., the user illustrated having a unique extension 1511) and a lister-side data 402 (e.g., the lister illustrated as having a unique phone number 800-555-2100). The user side data 400 includes actual user data 404 (e.g., actual phone numbers, email, and other information about a user such as the user 101 as shown in FIG. 1), and masked user data 406 (e.g., masked/proxy phone numbers, email, and other information about a user such as the user 101 as shown in FIG.1). The masked user data 406 may be generated by the mask module 110 according to one embodiment.

Similarly, in FIG. 4, the lister side data 402 includes actual lister data 408 (e.g., actual phone numbers, email, and other information about a lister such as the lister 104), and a masked lister data 410 (e.g., masked/proxy phone numbers, email, and other information about a lister such as the lister 104 as shown in FIG. 1). The masked lister data 410 may also be generated by the mask module 110 according to one embodiment. Referring now to FIG. 1, the mask table 114 may be used by the mask module 110 to convert actual contact information associated with the user 101 to masked information and/or vice-versa. In addition, mask table 114 may be used by the mask removal module 106 to convert a proxy telephone number associated with the lister 104 to an actual telephone number of the lister 104 and vice-versa.

For example, the mask removal module 106 (e.g., may be in a circuit switched telephone network and/or in an IP network such as the Internet 102) may reference the mask table 114 of FIG. 4 to convert the proxy telephone number (e.g., as previously generated by the mask module 110) of the lister 104 to an actual telephone number of the lister 104 based on a phone number entered. In addition, the mask removal module 106 may reference the mask table 114 to identify a particular user based on a code (e.g., an extension) entered by the lister 104 wishing to contact the user 101 via telephone according to an embodiment.

Referring back to FIG. 1, the online listing system 109 may identify a lister response (e.g., a rental manager following up on a lead received through the online listing system) to the user 101 (e.g., a user of the online listing system such as a potential renter of an apartment) based on a code (e.g., the code may be an extension entered after dialing a masked user telephone number such as a proxy telephone number) entered by the lister 104 after dialing a proxy telephone number (e.g., a ‘masked’ telephone number generated by the mask module 110 and substituting for the actual telephone number of the user 101), according to an embodiment. In addition, the billing module 108 of FIG. 1 may capture response history information when routing the proxy telephone number to the user 101.

In some example embodiments, a timer module 113 (e.g., code executed by the processor 132 of the transaction center server 112) may determine how long the lister 104 of the online listing system took to respond to an inquiry from the user 101. The online listing system 109 may also record one or more telephone calls between the user 101 and the lister 104 based on a contract (e.g., a binding agreement) between the user 101 and the lister 104 with a proprietor of the online listing system (e.g., an online listing system 109). The lister may be rental manager, a landlord, a mortgage broker, or a merchant, according to various embodiments. In addition, the transaction center server 112 may provide to the billing module 108 a periodic log of telephone numbers dialed between users of the online listing system such as the user 101 and, other users of the online listing system 109 and the lister 104.

In some example embodiments, a proxy telephone number generated by the mask module 110 is unique to a particular listing (e.g., a particular item or service offered for sale and/or lease) requested by the user 101, and the extension number (e.g., a telephone extension number) is unique to the user 101. The transaction center server 112 may send to the user 101 additional information about the particular listing based on the duration (e.g., amount of time) of the routed call. Every listing in the online listing system 109 may be associated with an item detail page (e.g., detailed information about a property for lease and/or sale) in the online listing system 109. The user 101 may contact the lister 104 through the proxy telephone number and/or a website lead form on the item detail page.

The billing module 108 may validate a transaction (e.g., a successful lease and/or sale) between the user 101 and the lister 104 based on the call history information and/or the website lead form. The billing module 108 may validate the transaction by automatically scanning (e.g., through an optical character recognition method) the call history information and/or the website lead form to determine whether a binding contract was formed between the parties (e.g., offer, acceptance, consideration). In some example embodiments, the billing module 108 may determine that there is more likely than not a binding contract formed between the parties, and on that basis an automatic signal is transmitted from the billing module 108 to an administrator of the online listing system 109 to follow up with the parties via telephone.

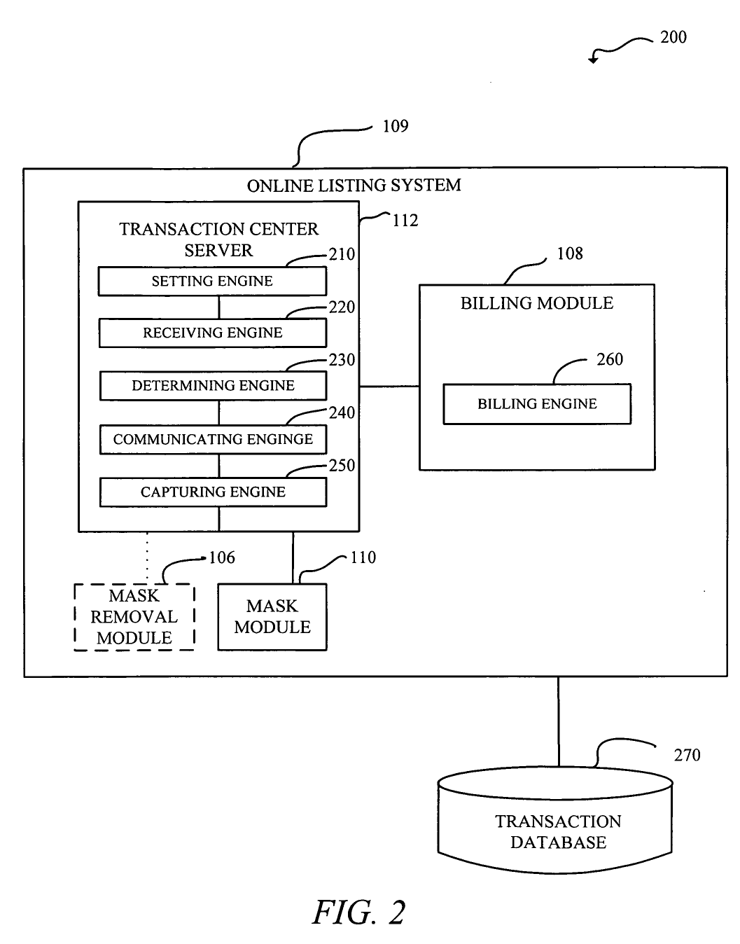

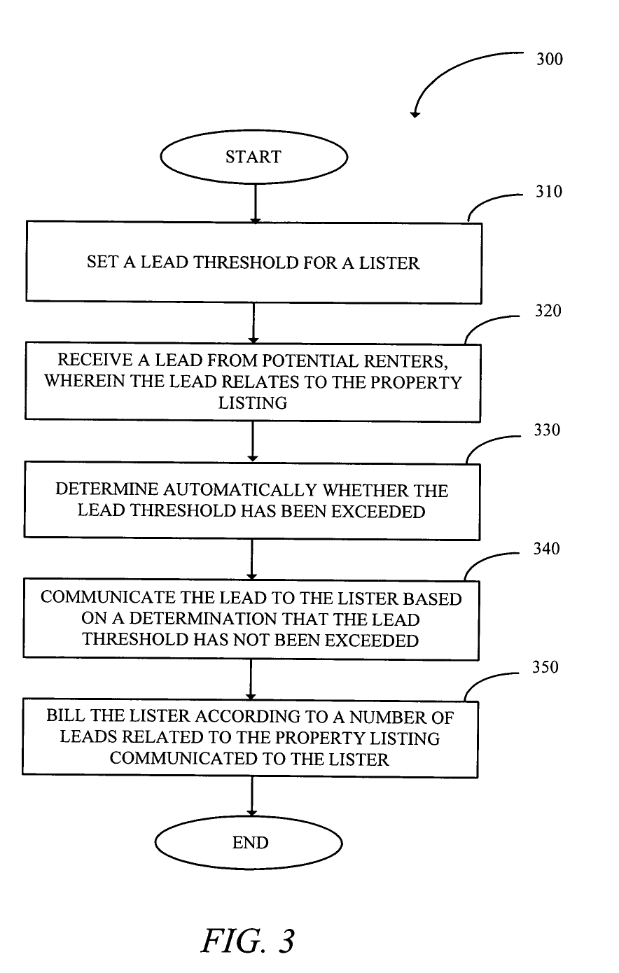

The billing module 108 may also generate a justification to a bill (e.g., a transaction based charge) to at least one of the user and the lister based on any one or more of the call history information and/or the website lead form. In addition, the transaction center server 112 may convert an actual email address of the user 101 entered in the website lead form to a proxy email address, and transmit the proxy email address to the lister 104. Furthermore, the mask module 110 of the transaction center server 112 may receive a call of the user 101 from multiple geographic sites (e.g., from the user's office and/or home location) prior to determining the identity of the user 101 dialing the proxy telephone number based on the extension number entered by the user 101. In addition, the transaction center server 112 may generate the extension based on a logic algorithm having a checksum; and bill the lister (e.g., through the billing module 108) according to the number of leads (e.g., phone calls or emails) received from one or more potential renters. More detailed explanation about the online listing system 109 is given below using FIG. 2-3.

FIG. 2 is a diagram of functional units of the online listing system 200 in accordance with an example embodiment. Illustrated in FIG. 2 is the online listing system 109. The online listing system 109 comprises the billing module 108, the transaction center server 112, the mask module 110 and the mask removal module 106. In some example embodiments, the mask removal module 106 may exist outside the online listing system 109 (e.g., in a circuit switched telephone network and/or in an IP network such as the Internet 102). These modules are operatively coupled to one another. The billing module 108 may run a billing engine 260. The transaction center server 112 may run a plurality of functional engines such as a setting engine 210, a receiving engine 220, a determining engine 230, a communicating engine 240 and a capturing engine 250, etc. Although the billing module 108 is shown as a separate module from the transaction center server 112, the two modules may be implemented as a single module in some example embodiments.

If one or more listers 104 list their property listings on the online listing system 109, the setting engine 210 may set a lead threshold for a lister. The lead threshold may specify a maximum number of leads relating to a property listing associated with the lister. The leads may be communicated to lister later. The lead threshold may also indicate a maximum number of leads for which the lister may be charged. In some example embodiments, the lead threshold may be specified for each listing for the respective lister. In some example embodiments, the setting engine 210 may determine the lead threshold based upon designation (e.g., instruction) received from the lister as to the number of leads related to the property listing desired by the lister. For example, the lister may designate one hundred as maximum lead number for which he is willing to pay. In some example embodiments, if an amount charged per lead is known to the lister (e.g., $100 per lead), the lister may designate the lead threshold by using a total amount of budget that he is willing to pay (e.g., $10,000 for 100 leads) to a runner of the online listing system 109. In some example embodiments, the setting engine 210 may additionally refer to previous transaction history for a respective lister to determine whether or not the lister is eligible for a reduced charge per lead and/or one or more free leads. The online listing system 109 may be operatively coupled to a transaction database 270 to store the transaction history between the potential renters and the listers. In some example embodiments, the transaction database 270 may be the mask database 116. In some example embodiments, the transaction database 270 may be coupled to the online listing system remotely, for example, via the Internet 102. Other suitable network, such as a local area network (LAN) or a wide area network (WAN) (not shown in FIG. 2), may be used to couple the transaction database 270 to the online listing system 109.

In some example embodiments, the setting engine 210 may change the lead threshold upon receipt of a request from the lister. For example, if the lister's budget for listing his properties is reduced for some reasons, then he may want to change the lead threshold accordingly and vice versa. Also, if the listed property is not available for rent any more (e.g., rented throughout other advertising sources or the property owner or manager's decision not to rent, etc.), then the lister may need to stop listing the property in the online listing system 109. In such cases, the setting engine 210 may receive the lister's request, for example, via the Internet 102 or a telephone network, and change the lead threshold according to the lister's request. In some example embodiments, the setting engine 210 may receive a valid identifier from a user purporting to be the lister to verify his identification. The valid identifier may include the lister's financial information, such as credit card or bank account information.

Once one or more properties are listed, one or more potential renters 101 may access the online listing system 109 via the Internet 102 and search the listings. If a property listing matching their search preferences, the potential renters may try to contact corresponding listers using, for example, proxy contact information generated by the mask module 110 as described above in FIG. 1. In some example embodiments, the potential renters may send the corresponding listers leads in a form of a telephone call or email based upon the proxy contact information. The receiving engine 220 may then receive one or more leads related to the property listing associated with the lister from potential renters. The determining engine 230 may then automatically determine whether the lead threshold set for the property listing associated with the lister has been exceeded. The online listing system 109 may keep track of transactions of the lister and store such information in its associated memory (not shown in FIG. 2). In some example embodiments, the transaction information for each lister including the number of leads communicated from the potential renters may be stored in the transaction database 270 and retrieved by the determining engine 230 as necessary.

If it is determined that the lead threshold has not been exceeded, the communicating engine 240 may then communicate the lead received from the potential renters to the lister to whose property listing the lead is directed. The communicating engine 240 may also notify the lister of a receipt of the leads. In notifying the lister, the communicating engine 240 may indicate the number of remaining leads to the lister before exceeding the lead threshold set for the property listing associated with the lister. Also, if the number of remaining leads reaches one of specified threshold numbers, the communicating engine 240 may send a message suggesting an extension of the lead threshold to the lister. The communicating engine 240 may further present the message in a different format (e.g., different coloring or using different text size, etc.) according to a corresponding predefined threshold number. When the lead threshold for the lister is set to be ten, for example, if eight leads have been received so far, then the extension request message may be presented in a red color and/or large font size (e.g., size 14) while presented in a yellow color and/or normal font size (e.g., size 10) if six leads have been received. In some example embodiments, the online listing transaction system 109 may run a notifying engine (not shown in FIG. 2) separate from the communicating engine 240 for such notification related purposes.

When potential renters send leads (e.g., contacts in a form of a phone call or email) to listers and the listers respond to the leads, such communications between the potential renters and the listers may be captured by the transaction center server 112 using, for example, the mask module 110 and the mask removal module 106. More detailed explanation about capturing the communication information between the potential renters and the listers are described in the patent application publication US 2007/0003038 A1. In some example embodiments, the transaction center server 112 may have a separate capturing engine 250 operatively coupled with the communicating engine 240 to capture and manage the communication information between the potential renters and the listers. In such a case, the billing module 108 may access the capturing engine 250 and get the information as necessary to bill a lister later (e.g., the number of leads sent to each lister).

When transactions between the potential renters and the listers (e.g., sending and responding to leads, etc.) are done, the billing engine 260 may bill each lister according to the number of leads received from the potential renters. In some example embodiments, the billing engine 260 may bill the respective lister for each listing associated with him. In some example embodiments, the billing engine 260 may conduct the billing process on a basis of a specified periodic time. For example, the listers may be billed every day, week, month or year, etc. Also, the billing engine 260 may change the specified periodic time (e.g., week) to another specified periodic time (e.g., month) and vice versa as necessary (e.g., upon receipt of a corresponding request by the lister).

When billing a lister, the billing engine 260 may also inactivate property listings associated with the lister. In some example embodiments, the billing engine may inactivate the property listings associated with the lister upon receipt of an inactivation request from the lister. For example, the lister may want to stop listing his properties on the online listing system 109 for some reasons. In such a case, the lister may send such a request to the online listing system 109 by simply pressing an “Inactivation” menu via a user interface (not shown in FIG. 2). In some example embodiments, the billing engine 260 may inactivate the property listings associated with the lister if the number of leads received from the potential renters reaches the lead threshold.

In some example embodiments, if one or more property listings are inactivated, the billing engine 260 may further reactivate the inactivated property listings upon receipt of an indication from the lister that an increased lead threshold is designated. In some example embodiments, if the number of leads received from the potential renters for a current periodic time does not reach the lead threshold (e.g., received 8 leads when the lead threshold is 10), the billing engine 260 may reset the lead threshold to its original value (e.g., 10) for a following periodic time. It is noted that each of the engines described above in FIG. 2 may be implemented by hardware (e.g., circuit), firmware, software or any combinations thereof. It is also noted that although each of the engines is described above as a separate module, the entire engines or some of the engines in FIG. 2 may be implemented as a single entity (e.g., module or circuit) and still maintain the same functionality.

FIG. 3 is a flow chart illustrating a method used to bill a lister according to the number of leads received from potential renters 300 in accordance with an example embodiment. At operation 310, a lead threshold may be set for a lister. The lead threshold may be set for each listing for the lister. The lead threshold may specify a maximum number of leads relating to a property listing that will be communicated to the lister. In some example embodiments, the lead threshold may be determined based upon designation (e.g., instruction) received from the lister as to the number of leads related to the property listing desired by the lister. In some example embodiments, the lead threshold may be changed upon receipt of a request from the lister. In some example embodiments, in setting the lead threshold for the lister, a valid user identifier may be received from a user who purports to be the lister. The valid user identifier may include financial information (e.g., credit card information or bank account information, etc.) of the lister. In some example embodiments, in setting the lead threshold, the lister's previous transaction history may be used to determine whether the lister is eligible for a reduced charge per lead or bonus free leads.

At operation 320, a number of leads may be received from one or more potential renters. The lead may relate to the property listing associated with the lister. At operation 330, it may be automatically determined whether the lead threshold set for the listing associated with the lister has been exceeded. At operation 340, if the lead threshold has not been exceeded, the lead received from the potential renters may be communicated to the lister. In some example embodiments, while communicated to the lister, the leads received from the potential renters may be notified to the lister. In some example embodiments, during the notification, the number of remaining leads may be indicated to the lister before the lead threshold is exceeded. In some example embodiments, a message suggesting an extension of the lead threshold may be sent to the lister during the indication if the number of remaining leads reaches one of specified threshold numbers (e.g., 1 or 2 out of 10). In some example embodiments, the message suggesting an extension of the lead threshold may be presented in a different format (e.g., different coloring or font size) according to a corresponding predefined threshold number. For example, when the lead threshold for the lister is 10, if eight leads have been received so far, then the extension request message may be presented in a red color and/or large font size (e.g., size 14) while presented in a yellow color and/or normal font size (e.g., size 10) if six leads have been received.

At operation 350, the lister may be billed according to the number of leads related to the property listing associated with the lister that are received from the potential renters. In some example embodiments, the billing may be done for each listing of the respective lister. In some example embodiments, the billing occurs on a basis of a specified periodic time (e.g., every week, month or year, etc.). The specified periodic time may be changed from one (e.g., week) to another (e.g., month), for example, upon receipt of a corresponding request from the lister. In some example embodiments, as the lister is billed, the property listing associated with the lister may be inactivated upon receipt of an inactivation request from the lister. In some example embodiments, the property listing associated with the lister may be inactivated if the number of leads received from the potential renters for a current periodic time does not reach a specified minimum target number during a target time interval. In some example embodiments, the property listing associated with the lister may be inactivated if the number of leads received from the potential renters reaches the lead threshold. In some example embodiments, if any property listings for the lister are inactivated, the inactivated property listing may be reactivated, for example, upon receipt of an indication from the lister that an increased lead threshold is designated. In some example embodiments, if the number of leads received from the potential renters for a current periodic time (e.g., July) does not reach the lead threshold set for the periodic time (e.g., receive eight leads during July when the lead threshold for July is ten), the lead threshold may be reset to its original value (e.g., ten) for a following periodic time (e.g., August).

### Example Database

Some example embodiments may include the various databases (e.g., the mask database 116 and the transaction database 270) being relational databases or in some example cases On Line Analytic Processing (OLAP)-based databases. In the case of relational databases, various tables (e.g., mask table 114) of data are created and data is inserted into, and/or selected from, these tables using SQL or some other database-query language known in the art. In the case of OLAP databases, one or more multi-dimensional cubes or hypercubes containing multidimensional data from which data is selected or into which data is inserted using Multidimensional Expressions (MDX) may be implemented. In the case of a database using tables and SQL, a database application such as, for example, MYSQL™, SQLSERVER™, Oracle 8I™, 10G™, or some other suitable database application may be used to manage the data. Here, the case of a database using cubes and MDX, a database using Multidimensional On Line Analytic Processing (MOLAP), Relational On Line Analytic Processing (ROLAP), Hybrid On Line Analytic Processing (HOLAP), or some other suitable database application may be used to manage the data. These tables or cubes made up of tables, in the case of, for example, ROLAP, are organized into a RDS or Object Relational Data Schema (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization, optimization algorithm known in the art.

### A Three-Tier Architecture

In some example embodiments, a method is illustrated as implemented in a distributed or non-distributed software application designed under a three-tier architecture paradigm, whereby the various components of computer code that implement this method may be categorized as belonging to one or more of these three tiers. Some example embodiments may include a first tier as an interface (e.g., an interface tier) that is relatively free from application processing. Further, a second tier may be a logic tier that performs application processing in the form of logical/mathematical manipulations of data inputted through the interface level, and that communicates the results of these logical/mathematical manipulations to the interface tier and/or to a backend or storage tier. These logical/mathematical manipulations may relate to certain business rules or processes that govern the software application as a whole. A third storage tier may be a persistent storage medium or non-persistent storage medium. In some example cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. This three-tier architecture may be implemented using one technology, or, as may be discussed below, a variety of technologies. This three-tier architecture, and the technologies through which it is implemented, may be executed on two or more computer systems organized in a server-client, peer-to-peer, or some other suitable configuration. Further, these three tiers may be distributed between more than one computer system as various software components.

### Component Design

Some example embodiments may include the above illustrated tiers and the processes or operations that make them up, as one or more software components. Common to many of these components is the ability to generate, use, and manipulate data. These components, and the functionality associated with each, may be used by client, server, or peer computer systems. These various components may be implemented by a computer system on an as-needed basis. These components may be written in an object-oriented computer language such that a component-oriented or object-oriented programming technique can be implemented using a Visual Component Library (VCL), Component Library for Cross Platform (CLX), JavaBeans (JB), Enterprise JavaBeans (EJB), Component Object Model (COM), Distributed Component Object Model (DCOM), or other suitable technique. These components may be linked to other components via various Application Programming interfaces (APIs), and then compiled into one complete server, client, and/or peer software application. Further, these APIs may be able to communicate through various distributed programming protocols as distributed computing components.

### Distributed Computing Components and Protocols

Some example embodiments may include remote procedure calls used to implement one or more of the above-illustrated components across a distributed programming environment as distributed computing components. For example, an interface component (e.g., an interface tier) may reside on a first computer system remotely located from a second computer system containing a logic component (e.g., a logic tier). These first and second computer systems may be configured in a server-client, peer-to-peer, or some other suitable configuration. These various components may be written using the above-illustrated object-oriented programming techniques, and can be written in the same programming language or a different programming language. Various protocols may be implemented to enable these various components to communicate regardless of the programming language used to write these components. For example, a component written in C++ may be able to communicate with another component written in the Java programming language using a distributed computing protocol such as a Common Object Request Broker Architecture (CORBA), a Simple Object Access Protocol (SOAP), or some other suitable protocol. Some example embodiments may include the use of one or more of these protocols with the various protocols outlined in the Open Systems Interconnection (OSI) model, or Transmission Control Protocol/Internet Protocol (TCP/IP) protocol stack model for defining the protocols used by a network to transmit data.

### A System of Transmission Between a Server and Client

Some example embodiments may use the OSI model or TCP/IP protocol stack model for defining the protocols used by a network to transmit data. In applying these models, a system of data transmission between a server and client or between peer computer systems is illustrated as a series of roughly five layers comprising: an application layer, a transport layer, a network layer, a data link layer, and a physical layer. In the case of software having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as the Internet, a Local Area Network (LAN), a Wide Area Network (WAN), or some other suitable network. In some example cases, “Internet” refers to a network of networks. These networks may use a variety of protocols for the exchange of data, including the aforementioned TCP/IP, and additionally Asynchronous Transfer Mode (ATM), Systems Network Architecture (SNA), or some other suitable protocol. These networks may be organized within a variety of topologies (e.g., a star topology) or structures.

### A Computer System

FIG. 5 is a diagram showing an example computer system 700 that executes a set of instructions to perform any one or more of the methodologies discussed herein. In some example embodiments, the machine operates as a standalone device or may be connected (e.g., networked) to other machines. In a networked deployment, the machine may operate in the capacity of a server or a client machine in server-client network environment or as a peer machine in a peer-to-peer (or distributed) network environment. The machine may be a PC, a tablet PC, a Set-Top Box (STB), a PDA, a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network, both perform tasks such as those illustrated in the above description.

The computer system 500 includes a processor 502 (e.g., a Central Processing Unit (CPU), a Graphics Processing Unit (GPU) or both), a main memory 501, and a static memory 506, which communicate with each other via a bus 508. The computer system 500 may further include a video display 510 (e.g., a Liquid Crystal Display (LCD) or a Cathode Ray Tube (CRT)). The computer system 500 also includes an alpha-numeric input device 517 (e.g., a keyboard), a User Interface (UI) cursor controller device 511 (e.g., a mouse), a drive unit 516, a signal generation device 519 (e.g., a speaker) and a network interface device (e.g., a transmitter) 520.

The drive unit 516 includes a machine-readable medium 522 on which is stored one or more sets of instructions and data structures (e.g., software) embodying or used by any one or more of the methodologies or functions illustrated herein. The software may also reside, completely or at least partially, within the main memory 501 and/or within the processor 502 during execution thereof by the computer system 500, the main memory 501 and the processor 502 also constituting machine-readable medium 522.

The instructions 521 may further be transmitted or received over a network 526 via the network interface device 520 using any one of a number of well-known transfer protocols (e.g., HTTP, Session Initiation Protocol (SIP)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, optical and magnetic medium, and carrier wave signals.

### Marketplace Applications

In some example embodiments, a system and method are illustrated to bill a lister for leads received from potential renters within a lead threshold. In some example embodiments, a system and method are illustrated to bill a lister for lead received from potential renters within a lead threshold. The system and method include setting a lead threshold for a lister. The lead threshold may specify a maximum number of leads relating to a property listing that will be communicated to the lister. The system and method include receiving a lead from potential renters. The lead may be related to the property listing associated with the lister. The system and method include automatically determining whether the lead threshold has been exceeded. The system and method include communicating the lead to the lister based on a determination that the lead threshold has not been exceeded. The system and method further include billing the lister according to a number of leads related to the property listing communicated to the lister.

### Additional Notes

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer-readable instructions for performing various methods. The code may form portions of computer program products. Further, the code may be tangibly stored on one or more volatile or non-volatile computer-readable media such as during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above “DETAILED DESCRIPTION” includes references to the accompanying drawings, which form a part of the “DETAILED DESCRIPTION.” The drawings show, by way of illustration, specific embodiments of the invention can be practiced. These embodiments are also referred to herein as “examples.” Such examples can include elements in addition to those shown and described. However, the present inventors also contemplate examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Description of Example Embodiments, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Description of Example Embodiments, with each claim standing on its own as a separate embodiment.

What is claimed is:

1. A computer-implemented method, comprising:
setting a lead threshold for a lister, the lead threshold specifying a maximum number of leads relating to a property listing to be communicated to the lister;
receiving a lead from potential renters, the lead relating to the property listing;
automatically determining whether the lead threshold has been exceeded;
based on a determination that the lead threshold has not been exceeded, communicating the lead to the lister; and
billing the lister according to a number of leads related to the property listing communicated to the lister.

2. The method of claim 1, wherein the setting further comprises determining the lead threshold based upon an instruction received from the lister as to the number of leads related to the property listing desired by the lister.

3. The method of claim 1, wherein the setting further comprises changing the lead threshold upon receipt of a request from the lister.

4. The method of claim 1, wherein the setting further comprises receiving a valid identifier from a user purporting to be the lister.

5. The method of claim 1, wherein the communicating further comprises notifying the lister of the received leads.

6. The method of claim 5, wherein the notifying further comprises indicating the number of remaining leads to the lister before exceeding the lead threshold.

7. The method of claim 6, wherein the indicating further comprises sending a message suggesting an extension of the lead threshold to the lister if the number of remaining leads reaches a threshold number.

8. The method of claim 7, wherein the sending further comprises presenting the message in a different format once the number of received leads exceeds a corresponding predefined threshold number.

9. The method of claim 1, wherein the billing occurs periodically.

10. The method of claim 1, wherein the billing further comprises inactivating the property listing associated with the lister upon receipt of an inactivation request from the lister.

11. The method of claim 1, wherein the billing further comprises inactivating the property listing associated with the lister if the number of leads received from the potential renters does not reach a specified minimum target number during a target time interval.

12. The method of claim 1, wherein the billing further comprises inactivating the property listing associated with the lister if the number of leads received from the potential renters reaches the lead threshold.

13. The method of claim 12, wherein the inactivating further comprises reactivating the inactivated property listing upon receipt of a request from the lister that an increased lead threshold is designated.

14. The method of claim 1, wherein the billing further comprises resetting the lead threshold to its original value for a following specified periodic time if the number of leads received from the potential renters for a current specified periodic time does not reach the lead threshold.

15. A computer system, comprising:
a setting engine to set a lead threshold for a lister, the lead threshold specifying a maximum number of leads relating to a property listing to be communicated to the lister;
a receiving engine to receive a lead from potential renters, the lead relating to the property listing;
a determining engine to automatically determine whether the lead threshold has been exceeded;
a communicating engine to communicate the lead to the lister based on a determination that the lead threshold has not been exceeded; and
a billing engine to bill the lister according to a number of leads related to the property listing communicated to the lister.

16. The system of claim 15, wherein the setting engine is further configured to determine the lead threshold based upon an instruction received from the lister as to the number of leads related to the property listing desired by the lister.

17. The system of claim 15, wherein the setting engine is further configured to change the lead threshold upon receipt of a request from the lister.

18. The system of claim 15, wherein the setting engine is further configured to receive a valid identifier from a user purporting to be the lister.

19. The system of claim 15, wherein the communicating engine is further configured to notify the lister of the received leads.

20. The system of claim 19, wherein the communicating engine is further configured, in notifying the lister, to indicate the number of remaining leads to the lister before exceeding the lead threshold.

21. The system of claim 20, wherein the communicating engine is further configured, in indicating the number of remaining leads, to send a message suggesting an extension of the lead threshold to the lister if the number of remaining leads reaches a threshold number.

22. The system of claim 21, wherein the communicating engine is further configured, in sending a message, to present the message in a different format once the number of received leads exceeds a corresponding predefined threshold number.

23. The system of claim 15, wherein the billing engine is further configured to bill the lister periodically.

24. The system of claim 15, wherein the billing engine is further configured to inactivate the property listing associated with the lister upon receipt of an inactivation request from the lister.

25. The system of claim 15, wherein the billing engine is further configured to inactivate the property listing associated with the lister if the number of leads received from the potential renters does not reach a specified minimum target number during a target time interval.

26. The system of claim 15, wherein the billing engine is further configured to inactivate the property listing associated with the lister if the number of leads received from the potential renters reaches the lead threshold.

27. The system of claim 26, wherein the billing engine is further configured to reactivate the inactivated property listing upon receipt of a request from the lister that an increased lead threshold is designated.

28. The system of claim 15, wherein the billing engine is further configured to reset the lead threshold to its original value for a following specified periodic time if the number of leads received from the potential renters for a current specified periodic time does not reach the lead threshold.

29. An apparatus, comprising:
means for setting a lead threshold for a lister, the lead threshold specifying a maximum number of leads relating to a property listing to be communicated to the lister;
means for receiving a lead from potential renters, the lead relating to the property listing;
means for automatically determining whether the lead threshold has been exceeded;
means for based on a determination that the lead threshold has not been exceeded, communicating the lead to the lister; and
means for billing the lister according to a number of leads related to the property listing communicated to the lister.

30. A computer-readable medium having instructions stored thereon that, when executed by a computer, cause the computer to:
set a lead threshold for a lister, the lead threshold specifying a maximum number of leads relating to a property listing to be communicated to the lister;
receive a lead from potential renters, the lead relating to the property listing;
automatically determine whether the lead threshold has been exceeded;
communicate the lead to the lister based on a determination that the lead threshold has not been exceeded; and
bill the lister according to a number of leads related to the property listing communicated to the lister.
